(19) United States
(12) Patent Application Publication
(10) Pub. No.: US 2004/0243441 A1
(43) Pub. Date: Dec. 2, 2004

(54) Personal and healthcare data financial management system

(76) Inventors: Siegfried Bocionek, Nuerenberg (DE); Robert Emmons Haskell, Chester Springs, PA (US)

Correspondence Address: Alexander J. Burke, Intellectual Property Department, 5th Floor, 170 Wood Avenue South, Iselin, NJ, 08830, US

(21) Appl. No.: 10/826,051

(22) Filed: Apr. 15, 2004

Related U.S. Application Data
(60) Provisional application No. 60/462,955, filed on Apr. 15, 2003.

(51) Int. Cl. G06F 17/60; G06F 17/00; G06F 7/00

(52) U.S. Cl. 705/2; 705/3; 707/104.1; 707/3

(57) ABSTRACT

A financial management system and method therefor enables an individual user to access and maintain healthcare records concerning encounters of an individual with a healthcare provider organization. The encounters include interactions of the individual with the healthcare provider organization that have a financial consequence. The financial management system includes an acquisition processor, a storage processor, a data processor, and an output processor. The acquisition processor receives, via electronic communication from a healthcare provider organization, information related to at least one healthcare encounter of an individual user. The storage processor stores the received healthcare encounter information. The data processor retrieves and processes the received healthcare encounter information to provide data, representing at least one record, indicating a history of encounters of the individual user with the healthcare provider organization. The output processor processes the data, representing the at least one record, for output in response to user command.

### CROSS-REFERENCE TO RELATED APPLICATIONS

The present application is a non-provisional application of provisional application having Ser. No. 60/462,955 filed by Siegfried Bocionek, et al. on Apr. 15, 2003.

### FIELD OF THE INVENTION

The present invention generally relates to financial management systems. More particularly, the present invention relates to a personal and healthcare data financial management system and method therefor.

### BACKGROUND OF THE INVENTION

Healthcare provider organizations send bills to patients for their co-pay or privately covered services. Healthcare provider organizations are interested in getting their payment as fast as possible. Further, consumers do not have a convenient way to maintain a history of encounters with a health care system, the services they receive during those encounters, the cost of these encounters, and a way to organize the information for payment, tax purposes, or health maintenance.

Present billing, payment, and record keeping systems are paper-based. The healthcare provider sends paper bills, having a summary of the encounters and charges, to the consumer via postal mail. The healthcare provider monitors the payment, administer accounts receivable (A/R) lists, send reminders, etc. The consumer has no automatic, electronic way of consolidating the billing data for reporting and heath record maintenance purposes.

Personal financial management packages have the capability to categorize and manage finances for an individual. Financial payments can be categorized and reported for year-end tax reporting or spending account management.

Present systems do not provide a direct connection between a healthcare provider's system and a consumer's personal computer. In some cases, a consumer might have Web access to a large health care provider, but there is no electronic link for communicating financial data electronically between a healthcare provider's system and the consumer's personal computer.

Accordingly, there is a need for a personal and healthcare data financial management system and method therefor that overcomes these and other disadvantages of the prior systems.

### SUMMARY OF THE INVENTION

According to one aspect of the present invention, a financial management system and method therefor enables an individual user to access and maintain healthcare records concerning encounters of an individual with a healthcare provider organization. The encounters include interactions of the individual with the healthcare provider organization that have a financial consequence. The financial management system includes an acquisition processor, a storage processor, a data processor, and an output processor. The acquisition processor receives, via electronic communication from a healthcare provider organization, information related to at least one healthcare encounter of an individual user. The storage processor stores the received healthcare encounter information. The data processor retrieves and processes the received healthcare encounter information to provide data, representing at least one record, indicating a history of encounters of the individual user with the healthcare provider organization. The output processor processes the data, representing the at least one record, for output in response to user command.

### BRIEF DESCRIPTION OF THE DRAWINGS

FIG. 1 illustrates a personal and healthcare data financial management system, in accordance with a preferred embodiment of the present invention.

FIG. 2 illustrates the consumer system for the system, shown in FIG. 1, in accordance with a preferred embodiment of the present invention.

FIG. 3 illustrates a personal and healthcare data financial management method for the system, shown in FIG. 1, in accordance with a preferred embodiment of the present invention.

FIG. 4 illustrates a personal healthcare accounting method for the method, shown in FIG. 2, in accordance with a preferred embodiment of the present invention.

FIG. 5 illustrates a display window on a user interface permitting a patient to register as a subscriber to the system, as shown in FIG. 1, in accordance with a preferred embodiment of the present invention.

FIG. 6 illustrates a display window on a user interface permitting a patient to access financial details for healthcare encounters recorded in the system, as shown in FIG. 1, in accordance with a preferred embodiment of the present invention.

FIG. 7 illustrates a display window on a user interface permitting the subscriber to access medical service details recorded in the system, as shown in FIG. 1, in accordance with a preferred embodiment of the present invention.

FIG. 8 illustrates a display window on a user interface permitting the subscriber to access flexible spending account activity recorded in the system, as shown in FIG. 1, in accordance with a preferred embodiment of the present invention.

FIG. 9 illustrates a display window on a user interface permitting the subscriber to access tax reports for the healthcare encounters recorded in the system, as shown in FIG. 1, in accordance with a preferred embodiment of the present invention.

FIG. 10 illustrates a paper bill for the subscriber, in accordance with a preferred embodiment of the present invention.

### DETAILED DESCRIPTION OF THE PREFERRED EMBODIMENTS

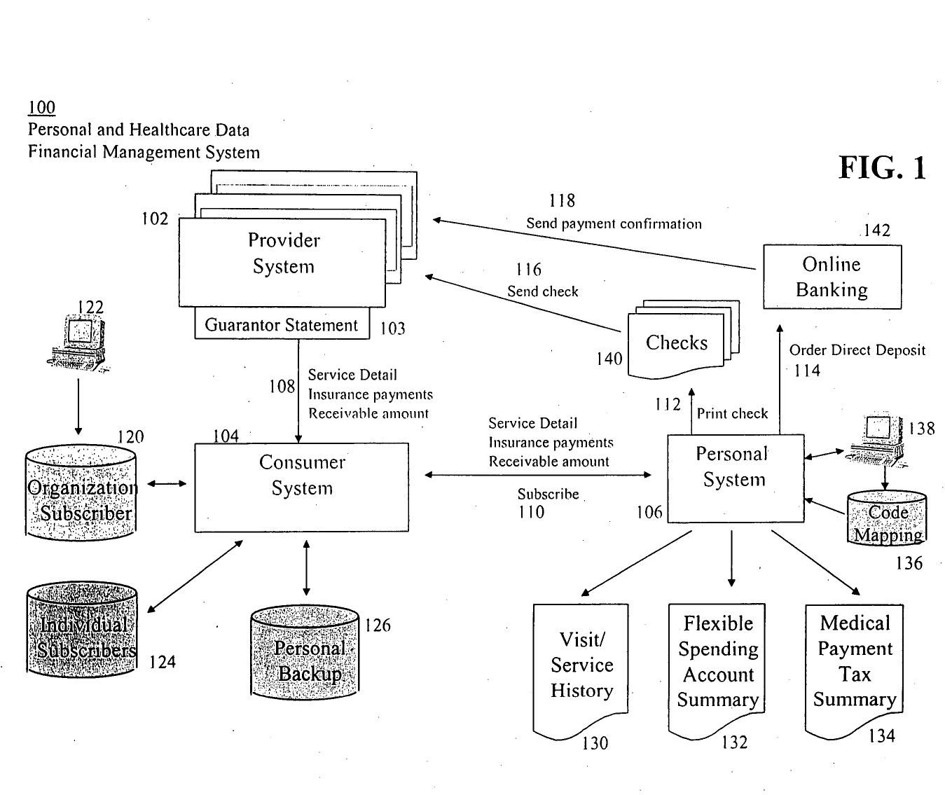

FIG. 1 illustrates a personal and healthcare data financial management system 100 (herein called the “system”), in accordance with a preferred embodiment of the present invention. The system 100 generally includes a provider system 102, a consumer system 104, and a personal system 106. The provider system 102 is electrically coupled to each of the consumer system 104 and the personal system. The consumer system is electrically coupled to the personal system 106.

The provider system 102 sends provider information 108, such as service detail, insurance payment, and receivable amounts, to the consumer system 104, and receives personal information, such as checks 116 and payment confirmations 118 from the personal system 106. The consumer system 104 sends consumer information 110, such as service detail, insurance payments, receivable amounts, and subscription information, to the personal system 106, and receives the provider information from the provider system 102. The personal system 106 receives the consumer information 110 from the consumer system and provides the personal information 116, 118 to the provider system 102.

The provider system 102 (otherwise called a “healthcare provider accounting system”) is preferably a healthcare information system (HIS). The provider system 102 may be operated on any type of electronic device including, without limitation, a personal computer, a server, and a workstation. One or more healthcare providers use one or more provider systems 102.

A healthcare provider is responsible for monitoring the health and/or welfare of people in its care, and may provide services directed to the mental, emotional, or physical well being of a person. A healthcare provider typically diagnoses a condition or a disease during an encounter with a person, and recommends a course of treatment to cure the condition, if such treatment exists, or provides preventative healthcare services. An encounter between the healthcare provider and the person includes any event involving the person and the healthcare provider interaction (e.g., patient visit, phone call, inpatient stay, examination, consultation, tests, treatment, etc.) that has a financial or transaction consequence.

Examples of healthcare providers include, without limitation, one or more hospitals, a healthcare enterprise a grouping of one or more physicians, an extended care facility, a nursing home, an assisted living care arrangement, a home health care agency, a hospice arrangement, a critical care arrangement, a health care clinic, a pharmacy, a physical therapy clinic, a test laboratory, a chiropractic clinic, a fitness center, a rehabilitation center, a diagnostic testing facility, and a dental office. In the exemplary embodiment of the present invention, the healthcare provider is a hospital.

The provider system 102 manages financial activity for the healthcare providers. Financial activity generally includes, without limitation, accounts payable and accounts receivable functions. More particularly, the financial activity includes billing and receiving payments for goods and services, submitting and collecting insurance payments, receiving cash, estimating reimbursements.

The provider system 102 provides data in the form of a guarantor statement 103. The guarantor statement 103 is a data structure that contains a guarantor's payment obligations to a healthcare provider and produces a bill for a guarantor of a financial obligation incurred by an encounter. The data structure includes detail service and procedure data, including service and procedure identification codes identifying services and procedures provided by a healthcare provider to a person. The service and procedure identification codes associated with each discrete service and payment are included in data downloaded from the provider system 102 to the personal system 106, via the consumer system 104, so that a service or procedure may be uniquely identified by the personal system 106.

A guarantor is a person who has received goods and/or services from a healthcare provider. A guarantor is usually the patient or a close relative of the patient. Examples of guarantors include, without limitation, a person, and a family that may be covered by the same health insurance plan. A bill or invoice may be derived from the guarantor statement 103 and sent in a paper format or electronically to the guarantor.

The consumer system 104 (otherwise called a “personal healthcare accounting controller” or “controller”) is preferably a consumer information system (CIS). The provider system 102 may be operated on any type of electronic device including, without limitation, a personal computer, a server, and a workstation. One or more consumer systems 104 may be coupled to one or more provider systems 102. The consumer system 104 may be offered by a single healthcare provider or as a centralized service for many healthcare providers offered through an application service provider (ASP).

The consumer system 104 generally represents an intermediate or bridge function between the provider system 102 and the personal system 106. The consumer system 104 advantageously provides an automated interface between the provider system 102 and the personal system 106 to electronically communicate provider information 108 to the personal system 106 and to promote payments from the personal system 106 back to the provider system 102.

The consumer system 104 performs functions including, without limitation, receiving the provider information 108 from the provider system 102, maintaining a copy of the provider information 108 for access by an authorized person, preparing the provider information 108 to be sent to the personal system 106, sending the provider information 108 to the personal system 106, managing the subscription of health care organizations and individuals to the service, and providing backup storage capability 126 for a person's healthcare transactions.

The consumer system 104 may receive the provider information 108 from the provider system 102 either automatically or responsive to a manual or automatic request from the consumer system 104. The consumer system 104 may send the consumer information 110 to the personal system 106 either automatically or responsive to a manual or automatic request from the personal system 106.

The consumer system 104 provides the functions as a service. The service may be in exchange for a fee. Any party including, without limitation, a subscriber, the healthcare provider, the individual, and the insurance provider may fund the fee for the service. The subscriber may be a healthcare provider 120, such as a healthcare organization, that can access the consumer system 104 via a personal computer 122. The subscriber may also be an individual 124. As an alternative to a subscription plan, users of the consumer system 104 may pay per use, per insurance plan, per transaction, etc. A healthcare provider may provide or pay for the service for its patients to encourage faster payments from insurance providers and/or individuals. An individual may subscribe to the service to electronically and efficiently manage their healthcare invoices, expenses, payments, and reporting. An insurance company may provide or pay for the service to encourage efficient financial transactions among the healthcare provider, the insurance company, and the individual. Hence, a variety of business plans may support the system 100.

The personal system 106 (otherwise called a “personal financial management system” is preferably a personal information system (PIS). One or more consumer systems 104 may be coupled to one or more personal systems 106. Many personal systems 106 may be electrically coupled to one consumer system 104. The personal system 106 represents local personal financial management software, such as Quicken® or Microsoft® Money®. Examples of the people being serviced by the healthcare provider and using the personal system 106 include, without limitation, a patient, a resident, and a client (each otherwise called a user or an individual).

The personal system 106 may be fixed or mobile (i.e., portable), and may be implemented in a variety of forms including, without limitation, a desktop computer, a laptop computer, a workstation, a network-based device, a personal digital assistant (PDA), a smart card, a cellular telephone, a pager, a wristwatch.

The personal system 106 includes functions, such as subscribing an individual to the service provided by the consumer system 104, collecting consumer information 111 (e.g., detail data) from the consumer system 104, keeping track of the date of last date sent to the personal system 104, updating a health care registry in the personal system 106, providing reporting and analysis capabilities against healthcare data, generating payments for unpaid balances. The personal system 106 provides reports including, without limitation, patient visit/service history 130 with the healthcare provider, a flexible spending account summary 132, and a medical tax summary 134. The personal system 106 also provides alerts and reminders (e.g., payment overdue, time for the annual check-up, etc.), which are initiated by visit and service dates and types (e.g., based on source of data), and includes service profiles (e.g., lists of drugs, lists of therapies, lists of visits, etc.). The personal system 106 derives, via the consumer system 104, many of these functions from a large healthcare provider database having readily available service-level financial data used for basic health maintenance.

The personal system 106 advantageously permits a patient or group of patients (e.g., a family) to efficiently manage their healthcare invoices, records, expenses, payments, and reporting. For example, the guarantor statement 103 provides family billing. The guarantor statement 103 groups various patient encounters with the healthcare provider and charges for multiple people into a single, consolidated bill. Such a grouping is used for parent and children, or some other arrangement between individuals. The guarantor statement 103 groups the services for separate individuals together for billing purposes, but they remain separate for clinical purposes. The personal system 106 maintains records for multiple family members (analogous to multiple accounts), by maintaining one for each family individual, for example. Hence, the personal system 106 provides the ability to summarize information and charges for one or more individuals that received goods and/or services from one or more healthcare providers.

The personal system 106 interfaces with the personal computer 138 and a code mapping function 136. After the personal system 106 receives the consumer information 110, service and procedure identification code are mapped to other summary codes that drive different reporting and analysis needs. For example, end of year tax reporting is mapped to tax treatment identification codes, and similar types of services are grouped into a general category such as drugs or a specific type of drugs like antibiotics. Preferably, the provider system 102 provides a standard code set and/or a set of mappings. A user of the personal system 106 may add or customize mappings as necessary for their own reporting needs. Particularly when data is being retrieved from multiple provider systems 102, wherein each provider systems 102 might have its own unique coding scheme, mapping is important to align service details to common categorization and reporting categories for the user of the personal system 106.

The personal system 106 generates payments 112 and 114 responsive to receiving the consumer information 110. The payments may be in the form of an instruction to generate a printed check 112 and/or an order for direct deposit 114. The instruction to generate a printed check 112 produces a check 140, which the patient sends to the healthcare provider to be recorded in the provider system 102. The order for direct deposit 114 is directed to an online bank 142, which makes the direct deposit into the healthcare provider's bank account and send a payment confirmation 118 to the provider system 102. A patient may configure the personal system 106 to automatically initiate payment related to one or more encounters by setting up an automatic payment instruction. Hence, a patient does not have to authorize every payment. Further, the patient may terminate an automatically initiated payment and payment instruction related to an encounter in response to a patient command.

The system 100 connects an individual's personal financial management software in the personal system 106 to healthcare information systems in the provider system 102 for the purpose of collecting detailed billing and payment information, facilitating the payment of health care bills, analyzing personal health care expenditures for tax or insurance management purposes, and maintaining a personal history of encounters and services received in the health care system. The system 100 helps healthcare consumers easily receive, track, organize, and pay healthcare-related bills, similar to automated interfaces for credit card and banking transactions, and to help maintain a historical record of health services received, as represented by the detail charges on the bill. Parts of the provider system 102, such as the guarantor statement 103, supports communication with a patient's personal financial management software, such as Quicken®, in the personal system 106 to provide electronic billing to the patient and direct deposit of the payment by the patient.

The system 100 provides a healthcare provider organization advantages including, without limitation, electronic billing and accounting (resulting in reduced full time equivalent (FTE) manpower), automated accounts receivable (A/R) monitoring, reduced A/R days due to faster invoicing and payment collection, and optimized cash flow through direct deposit procedures.

The system 100 provides a patient advantages including, without limitation, a means to directly import details of healthcare encounters maintained in the healthcare provider's healthcare information systems into the patient's personal computer software, a means to consolidate, maintain, and analyze the financial healthcare data using the standard features of the patients software, and a means to send online payments to healthcare providers. The system 100 is able to track monies due to healthcare providers, to organize data for year-end tax reporting, and to maintain a basic health history (e.g., encounters, services received during these encounters, reasons for the encounter). In the preferred embodiment, clinical data is not available, but detail service data provides sufficient information for financial purposes. A patient's bill may have information categorizing each service (e.g., by healthcare department). A particular data source may also be used to classify a type of service (e.g., dental bill).

In an alternative embodiment, the system 100 is implemented as a central application including a database with Web-based access. This embodiment may employ existing software products for particular long-term data storage and processing functions. The provider system 102 connects to a user's personal computer, advantageously permitting the complexity of the application logic used to be located in the provider system 102 and personal financial management software. This embodiment involves additional complexity in setting up and maintaining a central application able to trigger payment streams electronically in a secure way. The system 100 is applicable in any application involving importation of data into register/table structures. The system 100 is applicable to subscriptions to wellness centers, fitness centers, training centers where a person is only invoiced for services or lessons actually taken, for example. The system may also be implemented as a service provided by a processing center (e.g., by an application service provider (ASP)), or as an internal processing service in a hospital, and offered to healthcare providers (e.g., customers and non-customers) as a service offered to their patients, for example. Processing fees may be covered by healthcare provider organizations, as a service for their own customers. Multiple vendors to the provider system 102 may subscribe to such a central service. The system may also be employed within an individual healthcare provider organization.

In the system 100, one or more elements, such as the provider system 102, the consumer system 104, and the personal system 106, include one or more processors. As used herein, a processor comprises any one or combination of, hardware, firmware, and/or software. A processor acts upon stored and/or received information by manipulating, analyzing, modifying, converting, or transmitting information for use by an executable procedure or an information device, and/or by routing the information to an output device. A processor may use or comprise the capabilities of a controller or microprocessor, for example. A processor performs tasks responsive to processing an object. An object, as used herein, comprises a grouping of data and/or executable instructions, an executable procedure, or an executable application. An executable application, as used herein, comprises code or machine readable instruction for implementing predetermined functions including those of an operating system, healthcare information system or other information processing system, for example, in response user command or input. An executable procedure as used herein is a segment of code (machine readable instruction), sub-routine, or other distinct section of code or portion of an executable application for performing one or more particular processes and may include performing operations on received input parameters (or in response to received input parameters) and provide resulting output parameters. A calling procedure is a procedure for enabling execution of another procedure in response to a received command or instruction.

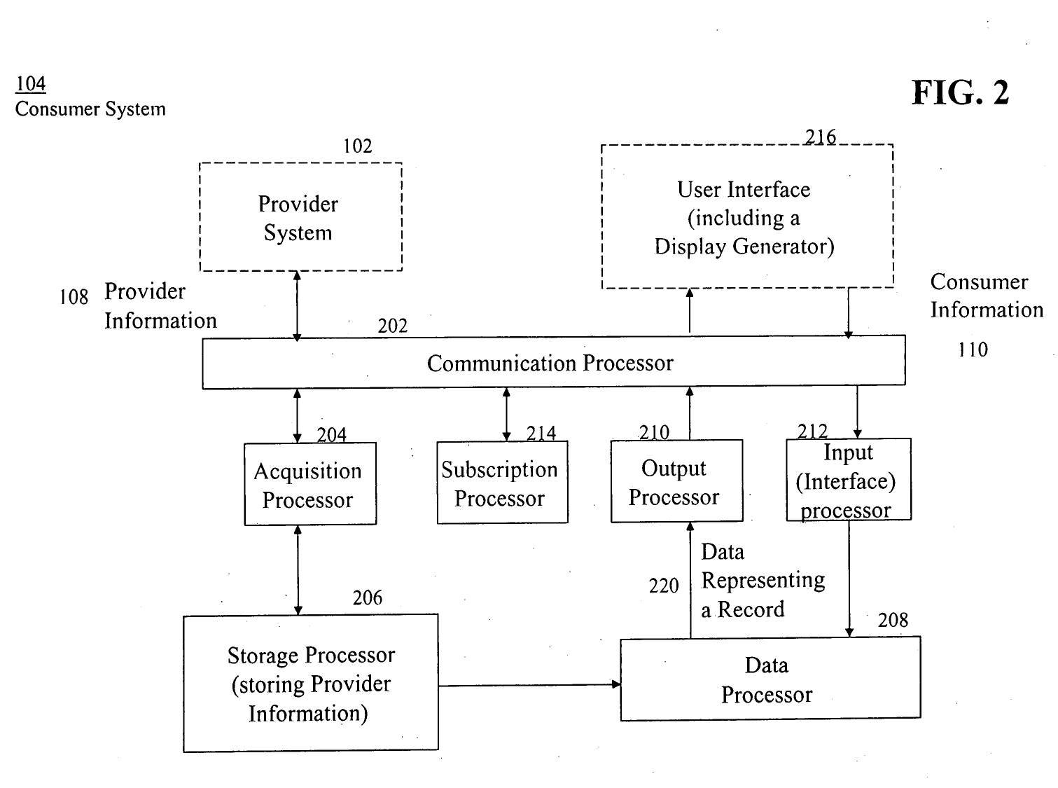

FIG. 2 illustrates the consumer system 104 for the system 100, shown in FIG. 1, in accordance with a preferred embodiment of the present invention. In another embodiment, one or more elements and functions of FIG. 2 may be employed by the personal system 106. The consumer system 104 generally includes a communication processor 202, an acquisition processor 204, a storage processor 206, a data processor 208, an output processor 210, a user interface processor 212, and a subscription processor 214.

The communication processor 202 is electrically coupled to send and receive information between the consumer system 104 and each of the provider system 102 and a user interface 216 over one or more communication paths. The term “path” may otherwise be called a network, a link, a channel, or a connection. The communication path may be the same path or different paths for each of the provider system 102 and a user interface 216, depending on the particular design of the system 100.

The communication path may use any type of protocol, otherwise called data format, including, without limitation, an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, an Institute Of Electrical And Electronic Engineers (IEEE) bus compatible protocol, and an Health Level Seven (HL7) protocol.

The communication path may use any type of address scheme including, without limitation, an address corresponding to a type of protocol described above, and a Universal Resource Locator (URL), otherwise called a web page address. The communication path may communicate any type of data for any type of application including, without limitation, still pictures, streaming video, audio, telephone messages, computer programs, messages, instructions, and Emails.

The communication path may be formed as a wired and/or wireless (W/WL) connection. A wireless connection advantageously permits elements of the system 100 to be mobile beyond the distance permitted by the wired connection. In the preferred embodiment, the communication path is formed as a wired connection. The wired connection may include physical wires formed as a serial or parallel bus. In the case of a wired connection, an IP. address may be assigned to a physical location of the termination point of the wire. In the case of a wireless connection, the IP address may be assigned to the mobile element, since the element would be mobile.

The communication path may be formed as any type of network including, without limitation, a local area network (LAN), such as an Intranet, for example, and a wide area network (WAN), such as an Internet, for example. In the preferred embodiment, the communication path is formed as the WAN, such as the Internet. The Internet is a decentralized network of computers that communicate with one another via TCP/IP. The explosive growth in use of the Internet is due in part to the development in the early 1990's of the worldwide web (WWW), which is one of several services provided on the Internet. Other services include, without limitation, communication services such as Email, file transfer protocol (FTP), telnet, newsgroups, internet relay chat (IRC), instant messaging, information search services such as Google™ and AltaVista™, and information retrieval services such as file transfer protocol (FTP).

In the case of a wired connection to the provider system 102 and/or the user interface 212, the consumer system 104 may be considered a server, and the provider system 102 and/or the user interface 212 may be considered a client. A web browser, such as Explorer™ (MicroSoft Corp.) or Navigator™ (Netscape Communication Corp.), sends a request over the WWW to a server requesting a web page identified by a uniform resource locator (URL), which notes both the server where the web page resides and the file or files on that server which make up the web page. The server sends a copy of the requested file(s) to the web browser, which in turn displays the web page to the user. The web pages on the WWW may be hyper-media documents written in a standardized language called Hyper Text Markup Language (HTML). A typical web page includes text together with embedded formatting commands, referred to as tags, which can be used to control font size, font style and the like.

In operation, the communication processor 202 establishes communication with an information system 102 of the healthcare provider organization for acquiring the information 108 related to one or more healthcare encounters of the individual user. The communication processor 202 establishes communication with the information system 102 of the healthcare provider organization for acquiring the information 108 related to the at least one healthcare encounter of the individual user in response to one or more of: (a) a command of the individual user, and (b) predetermined computerized instruction to establish repetitive intermittent communication. The communication processor 202 provides, to the information system 102, identification information of the individual user together with one or more of: (i) a password, and (ii) information identifying the authorization of the individual user to access the information system 102.

The user interface 216 is associated with the personal system 106, and in particular is associated with the personal computer 138, or other electronic device, running the personal financial software. The user interface 216 in the personal system 106 includes an input device (not shown) that permits a user to input information into the personal system 106 and an output device (not shown) that permits a user to receive information from the personal system 106. In the preferred embodiment, the input device is a keyboard, but also may be a touch screen, or a microphone with a voice recognition program, for example. In the preferred embodiment, the output device is a display, but also may be a speaker, for example. The output device provides information to the user responsive to the input device receiving information from a user or responsive to other activity by the personal system 106. For example, a display presents information responsive to a user entering information in the personal system 106 via a keyboard.

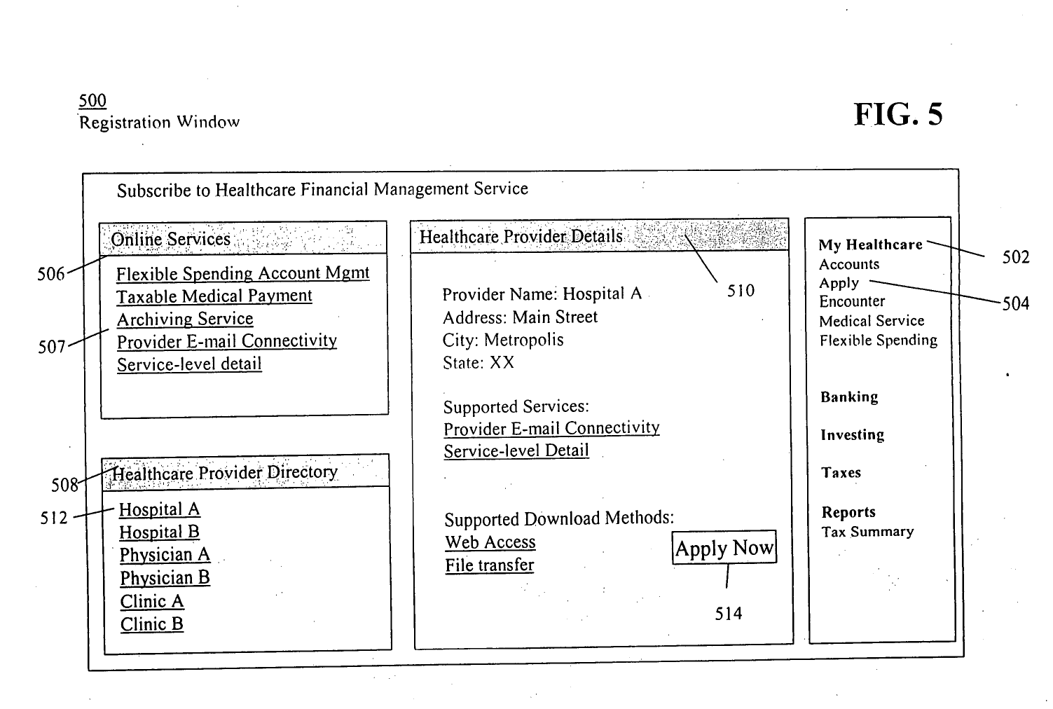

Browser software (not shown) stored in the personal computer 138 cooperates with the user interface 216 by permitting information to be entered into the browser software and by permitting information to be displayed by the browser software. The user interface 216 includes a display generator that provides data representing a display image including information shown in FIGS. 5-9.

In the preferred embodiment, the user interface 216 is a graphical user interface (GUI), wherein at least portions of the input device and at least portions of the output device are integrated together to provide a user-friendly device. For example, a web browser forms a part of each of the input device and the output device by permitting information to be entered into the web browser and by permitting information to be displayed by the web browser. Many different GUI techniques for inputting data and outputting data, such as using a browser interface, may be implemented for efficiency and ease of use including, without limitation, selection lists, selection icons, selection indicators, drop down menus, entry boxes, slide bars, search queries, hypertext links, Boolean logic, template fields, natural language, stored predetermined queries, system feedback, and system prompts. The healthcare provider 102 and/or the consumer system 104 may also have a user interface (not shown), having an input device and an output device, which operates in the same or different way than the user interface 216.

Each of the remaining processors, including processors 204, 206, 208, 210, 212, and 214, as well as the communication processor 202, may be the same or different processing elements. FIG. 2 illustrates the processing elements 202, 204, 206, 208, 210, 212, and 214 as seven separate processing elements to highlight various aspects and functions of the consumer system 104. The processing elements 202, 204, 206, 208, 210, 212, and 214 may be implemented in software, hardware, or in a combination of software and hardware.

The memory processor 206 stores provider information 108 received from the provider system 102. The provider information 108 (including “healthcare encounter information”) represents health care information related to the person being serviced by the health care provider. The provider information 108 represents financial information related to the encounters of the patient with the healthcare provider. Alternatively or in combination, the provider information 108 may also include an organized collection of clinical information concerning one patient's relationship to health care provided by a healthcare provider. The healthcare provider documents the healthcare using order sets and document templates.

The provider information 108 generally includes case management information and/or claim processing information related to a patient's healthcare. For example, the health care information may include, without limitation and either alone or in combination: patient census information, clinical reports, images, documents and data associated with a patient record, patient record scanned documents, detailed information about a particular patient, patient medical eligibility determination related information, patient admission, discharge, and transfer related information, patient clinical information, patient care plan information, workflow information, patient bibliographic information, patient demographic information, patient vital signs, patient financial information, patient accounting and billing information, and characteristics of the patient including, without limitation, the person's age, sex, and health condition.

The provider information 108 are generated, originated, or sourced by one or more various healthcare sources within the provider system 102. Examples of the healthcare sources include, without limitation, a hospital system, a medical system, and a physician system, a records system, a radiology system, an accounting system, a billing system, and any other system required or desired in a provider system 102. The hospital system further includes, without limitation, a lab system, a pharmacy system, a financial system, and a nursing system. The medical system, otherwise called an enterprise, represents a healthcare clinic or another hospital system. The physician system represents a physician's office.

The provider information 108 may be represented in a variety of file formats including, without limitation and in any combination, numeric files, text files, graphic files, video files, audio files, and visual files. The graphic files include a graphical trace including, for example, an electrocardiogram (ECG) trace, and an electroencephalogram (EEG) trace. The video files include a still video image or a video image sequence. The audio files include an audio sound or an audio segment. The visual files include a diagnostic image including, for example, a magnetic resonance image (MRI), an X-ray, a positron emission tomography (PET) scan, or a sonogram.

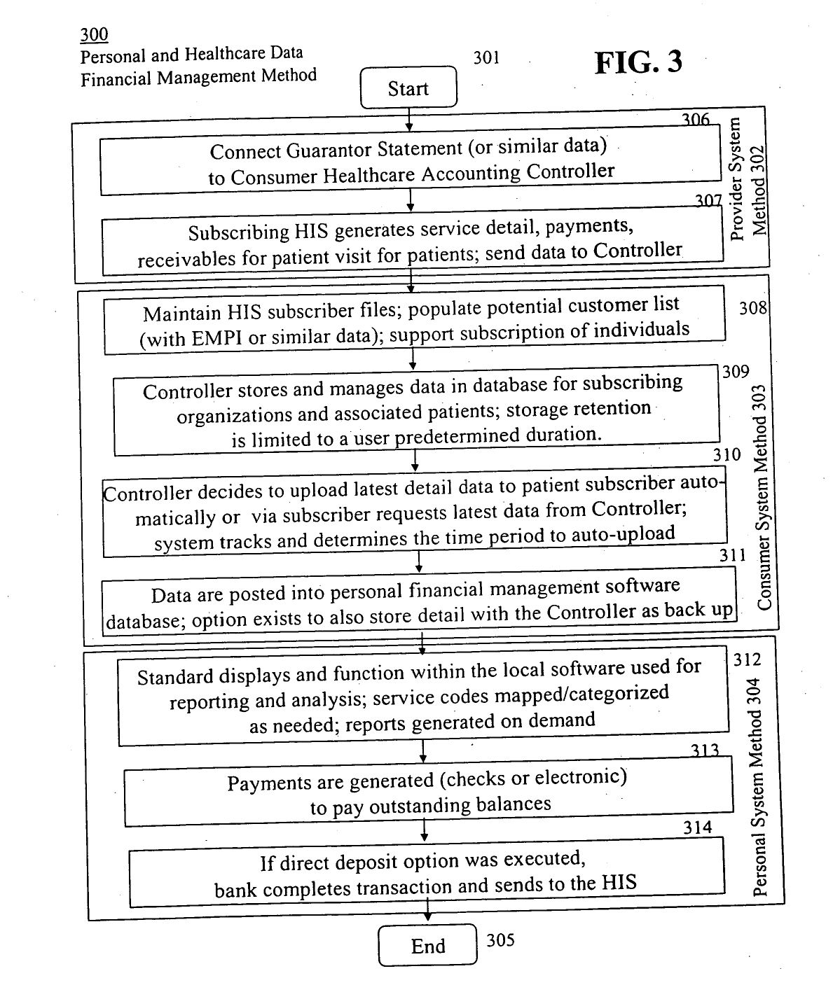

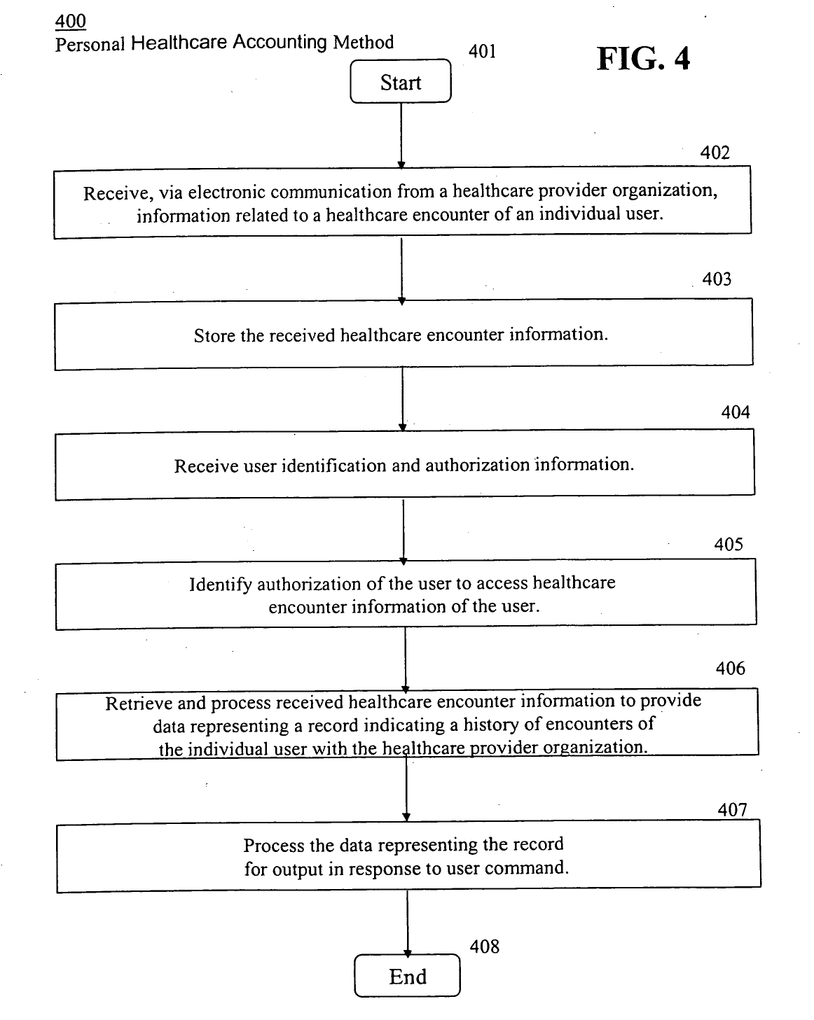

The memory processor 206, storing the provider information 108, may be implemented in random access memory (RAM), or other suitable memory unit that can be refreshed, cached, or updated while the consumer system 104 is in use. The memory processor 206 also stores the general consumer method 300, shown in FIG. 3, and the detailed consumer method 400, shown in FIG. 4. The memory processor 206 that holds software to implement the methods 300 and 400 may be implemented in read only memory (ROM), or other suitable memory unit, which runs a predetermined software program while the consumer system 104 is in use.

In operation, the consumer system 104 enables an individual user to access and maintain healthcare records concerning encounters of an individual with a healthcare provider organization 102 (technically represented herein by the provider system 102). The encounters include interactions of the individual with the healthcare provider organization having a financial consequence. The acquisition processor 204 receives, via electronic communication 202 from a healthcare provider organization 102, information 108 related to at least one healthcare encounter of an individual user. The storage processor 206 stores the received healthcare encounter information. The data processor 208 retrieves and processes the received healthcare encounter information to provide data 220 representing one or more records indicating a history of encounters of the individual user with the healthcare provider organization 102. The output processor 210 processes the data 220, representing the one or more records for outputting, in response to user command.

The data processor 208 processes the received healthcare encounter information 108 to provide data 220 representing one or more records. Examples of the records include, without limitation, (a) a record collating encounter information for encounters subject to similar taxation treatment, (b) a record collating encounter information for encounters subject reimbursement under a particular reimbursement plan, and (c) a record collating encounter information for encounters to be paid for by the individual user. The record collating encounter information for encounters subject to common taxation treatment collates encounter information by type of service provided to the individual user during an encounter. Examples the types of service include, without limitation, (a) a medical service, (b) a dental service, (c) an education service, and (d) a dependent care related service, and (e) a flexible spending account related service.

The data processor 208 processes the received healthcare encounter information 108 by automatically identifying a type of service identified in the received healthcare encounter information 108 by parsing the received healthcare encounter information to identify encounter identification codes. The data processor 208 uses the identified encounter identification codes to identify one or more of: (a) a particular service, and (b) a particular procedure associated with an encounter. The data processor 208 maps the identified identification code to a different code and uses the different code in processing received healthcare encounter information.

The display generator in the user interface 216 initiates generation of data representing a display image presenting the encounter history information. The data processor 208 prompts the individual user to initiate payment related to an encounter indicated by the encounter history information. The data processor 208 performs one or more tasks including, without limitation, (a) automatically initiating payment related to an encounter indicated by the encounter history information in response to predetermined payment instruction entered by a user, and (b) terminating an automatically initiated payment related to an encounter in response to user command. The data processor 208 prompts the individual user to initiate payment related to an encounter indicated by the encounter history information by one or more methods including, without limitation, (a) electronic funds transfer, (b) credit card, and (b) a manual payment method. Alternatively, one or more functions of the data processor 208 may be performed by the personal system 106.

The output processor 210 processes the data 220 representing one or more records for output in one or more forms selected from the following list: (a) electronic form, (b) a printed report form, (c) a file suitable for communication via the Internet, and (d) as data representing a display image for presentation to a user.

The storage processor 206 monitors updates of the stored received healthcare encounter information 108 by maintaining one or more of: (a) a date, and (b) a time, of an update to the stored received healthcare encounter information.

The received healthcare encounter information 108 comprises one or more of the following: (a) an identification of a service provided during an encounter, (b) an identification of a type of patient visit comprising an encounter, (c) a date of an encounter, (d) at least a portion of financial cost of an encounter due to be paid by the individual user, (e) a financial cost of an encounter, (f) an identification of an insurance company responsible for at least a portion of a financial cost of an encounter, (g) identification of a payment made by a user or insurance company towards cost of an encounter, and (h) an estimated reimbursement amount towards cost of an encounter.

The acquisition processor 204 receives family information 108 comprising information concerning one or more healthcare encounters of a person related to the individual user. The data processor 208 processes the received family information 108 to provide data representing one or more records indicating a history of encounters of the related person.

The acquisition processor 204 receives multi-organization information 108 identifying multiple encounters of the individual user with multiple different organizations. The data processor 208 processes the received multi-organization information 108 to provide data representing one or more records indicating a history of encounters of the individual user with the multiple different organizations.

The acquisition processor 204 receives multi-organization information identifying multiple encounters of the individual user with multiple different organizations. The data processor 208 processes the received multi-organization information to provide data representing one or more of the following: (a) a record identifying encounters of the individual user with multiple different organizations and the identified encounters subject to common taxation treatment, (b) a record identifying encounters of the individual user with multiple different organizations subject reimbursement under a particular reimbursement plan, and (c) a record identifying encounters of the individual user with multiple different organizations to be paid for by the individual user.

The data processor 208 processes the received healthcare encounter information to initiate generation of a message to the individual user. The message includes one or more of the following: (a) an alert concerning healthcare of the individual user, and (b) a reminder concerning a payment to be made concerning an encounter.

The interface processor 212 receives user identification and authorization information from the user interface 216 for identifying authorization of the user to access the healthcare encounter information 108 of the user. The data processor 208 retrieves the healthcare encounter information 108 of the identified user from storage 206, and formats the retrieved healthcare encounter information 108 of the user for communication to a user communication address. The communication processor 202 communicates the formatted healthcare encounter information to the user communication address.

The data processor 208 initiates retrieving the healthcare encounter information 108 in response to one or more of the following: (a) a received request for download of the healthcare encounter information 108 of the user, and (b) predetermined computerized instruction to establish repetitive intermittent download of the healthcare encounter information 108 to the user destination address.

The consumer system 104 is provided as a service to a subscriber. The consumer system 104 includes a subscription processor 214 for managing subscription of one or more of the following: (a) an individual user, and (b) a healthcare organization, to provide the service.

The received healthcare encounter information 108 includes one or more of the following: (a) an identification of a service provided during an encounter, (b) an identification of a type of patient visit comprising an encounter, (c) a date of an encounter, (d) at least a portion of financial cost of an encounter due to be paid by the individual user, (e) a financial cost of an encounter, (f) an identification of an insurance company responsible for at least a portion of a financial cost of an encounter, (g) identification of a payment made by a user or insurance company towards cost of an encounter, and (h) an estimated reimbursement amount towards cost of an encounter.

The interface processor 212 receives notice of a payment related to an encounter performed by one or more of the following: (a) electronic funds transfer, (b) credit card, (c) a manual payment method, and (d) an automatically initiated payment made in response to predetermined payment instruction entered by a user.

The formatted healthcare encounter information 108 includes encounter identification codes for identifying one or more of the following: (a) a particular service, and (b) a particular procedure associated with an encounter.

The formatted healthcare encounter information 108 includes a map for use in translating an identified identification code to a different code.

FIG. 3 illustrates a personal and healthcare data financial management method 300 for the system 100, shown in FIG. 1, in accordance with a preferred embodiment of the present invention.

At step 301, the method 300 starts.

At step 302, the method 300 performs steps 306-307 taken by the provider system 102.

At step 303, the method 300 performs steps 308-311 taken by the consumer system 104.

At step 304, the method 300 performs steps 312-314 taken by the personal system 106.

At step 305, the method 300 ends.

In particular, at step 306, the provider system 102 communicates the provider information 108 to the consumer system 104. The provider information 108 is derived from the guarantor statement 103 or similar data.

At step 307, the provider system 102 generates the provider information 108, such as service detail, payments, and receivables, for encounters between the patient and the healthcare provider, and sends the provider information 108 to the consumer system 104.

In particular, at step 308, the consumer system 104 receives the provider information 108, maintains subscriber files for the provider system 102, populates potential customer list (e.g., using enterprise master patient index (EMPI) or similar data), and supports subscription of individual users.

At step 309, the consumer system 104 stores and manages the provider information 108 in database for subscribing organizations and associated patients. Preferably, the storage retention is limited to a user-predetermined duration.

At step 310, the consumer system 104 determines whether to upload latest provider information 108, in the form of detail data, to patient subscriber, automatically or responsive to a subscriber requests. The consumer system 104 tracks and determines the time at which to automatically upload.

At step 311, the consumer system 104 posts the consumer information 110 to the personal system 106, in the form of a personal financial management software database, responsive to the determination at step 310. The consumer system 104 may also store the provider information 108 with the consumer system 104 as back up.

In particular, at step 312, the personal system 106 uses standard displays and functions within the personal financial management software to provide reporting and analysis. The service codes are mapped and categorized as needed, and reports generated on demand.

At step 313, the personal system 106 generates payments (e.g., paper checks or electronic) to pay outstanding balances due to the healthcare provider.

At step 314, the personal system 106 instructs a bank to complete the transaction and send payment to the provider system 102, if a direct deposit option was executed.

FIG. 4 illustrates a personal healthcare accounting method 400 for the method 300, shown in FIG. 2, in accordance with a preferred embodiment of the present invention. The method 400 enables an individual user to access and maintain healthcare records concerning encounters of an individual with a healthcare provider organization.

At step 401, the method 400 starts.

At step 402, the personal system 106 receives, via electronic communication from a healthcare provider organization 102, information 108 related to a healthcare encounter of an individual user.

At step 403, the personal system 106 stores the received healthcare encounter information 108.

At step 404, the personal system 106 receives user identification and authorization information.

At step 405, the personal system 106 identifies authorization of the user to access healthcare encounter information 108 the user.

At step 406, the personal system 106 retrieves the healthcare encounter information 108 of the identified user from storage, and processes received healthcare encounter information 108 to provide data 220 representing a record indicating a history of encounters of the individual user with the healthcare provider organization 102. The personal system 106 processes received healthcare encounter information 108 by formatting the retrieved healthcare encounter information 108 of the user for communication to a user communication address.

At step 407, the personal system 106 processes the data 220 representing the record for output in response to user command. The personal system 106 initiates communication of the formatted healthcare encounter information 108 to the user communication address

At step 408, the method 400 ends.

FIGS. 5-9 illustrates display windows on the user interface 212 that provide functions of existing personal healthcare management software packages that are preferably used in the personal system 106. The display windows provide functions which may be incorporated into a personal software package, such as Quicken®, a personal financial management software package used by many consumers. Preferably, the display windows shown in FIGS. 5-9 are incorporated into or formed as browser windows, having menus, icons, scroll bars, etc. (not shown in FIGS. 5-9) that are well known to those skilled in the art of browser windows.

In FIGS. 5-9, appropriate user identification and secure connectivity are established for initial and ongoing communication. Data may be received from the consumer system 104 automatically in an “always on” environment, or by a request from the user.

Preferably, the information provided in FIGS. 5-9, although more financial than directly clinical, is used to maintain an electronic health record of patient encounters with the healthcare provider. With primary care physicians and pharmacies connected to such a network, the amount of information provided to the user is quite specific and useful. Preferably, clinical results are not available in this fashion, but the identification of those services that were specifically billed is available. Alternatively, the system 100 may be designed so that a user can access the clinical results stored in the consumer system 104 or in the provider system 102, if desired or required.

FIG. 5 illustrates a display window 500 on the user interface 212 permitting a patient to register as a subscriber to the system 100, as shown in FIG. 1, in accordance with a preferred embodiment of the present invention. The display window 500 generally includes a menu section 502 including individual menu selections, a healthcare services section 506 including links to various healthcare services 507, a healthcare provider directory section 508 including links to various healthcare providers 512, and a healthcare provider detail section 510 including detailed information about a selected healthcare provider, and an “Apply Now” selection box 514.

The menu section 502 includes several menus such as, for example, “My Healthcare,” “Banking,” “Investing,” “Taxes,” and “Reports.” The “My Healthcare” menu further includes sub-menus such as, for example, “Accounts,” “Apply” 504, “Encounter,” “Medical Service,” and “Flexible Spending.” The “Reports” menu further includes sub-menu such as, for example, “Tax Summary.”

In operation, the user, such as the patient, electronically opens or starts the personal software package in the personal system 106. The user selects the sub-menu “Apply” to open the registration window 500. The user selects a preferred healthcare provider 512, such as “Hospital A,” under the healthcare provider directory section 508. The details of the selected preferred healthcare provider 512 appear under the healthcare provider details section 510. If the details of the selected preferred healthcare provider 512 that appear under the healthcare provider details section 510 are acceptable to the user, the user selects the “Apply Now” box 514 to apply or subscribe with the selected healthcare provider.

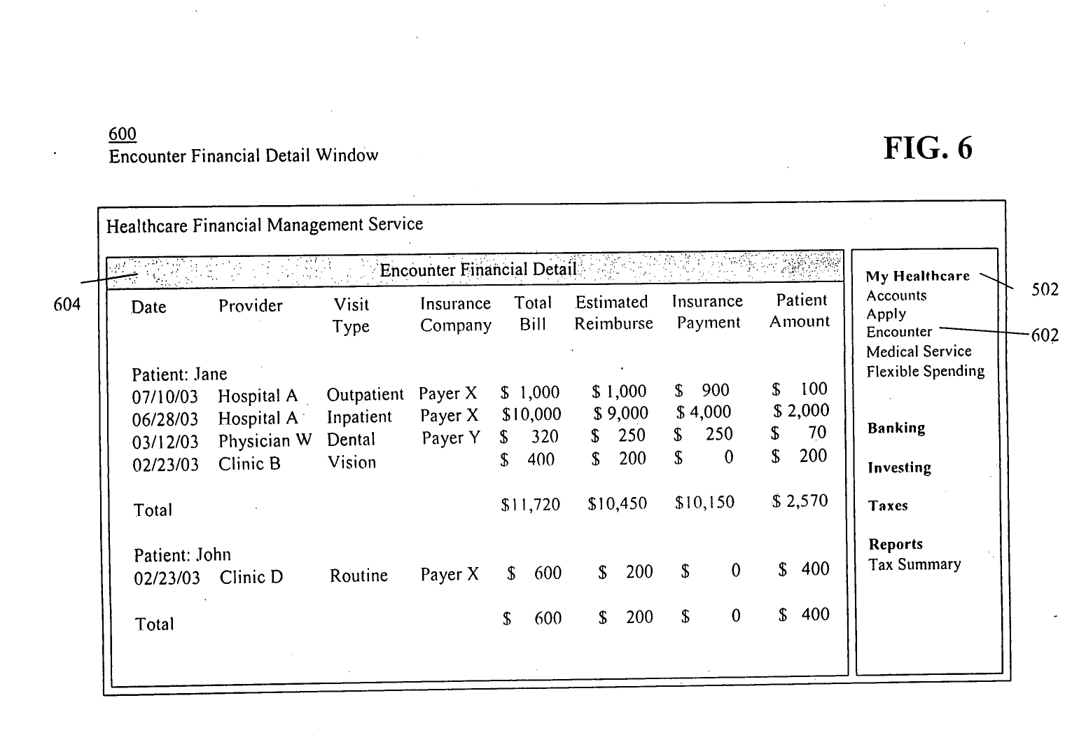

FIG. 6 illustrates a display window 600 on a user interface 212 permitting a patient to access financial details for healthcare encounters recorded in the system 100, as shown in FIG. 1, in accordance with a preferred embodiment of the present invention. The user (i.e., subscriber) selects the “Encounter” sub-menu 602 to open a healthcare encounter financial details section 604. The section 604 permits the user to access financial details of their healthcare encounters with their healthcare providers. The financial details are provided for one or more patients (e.g., Jane and John), such as patients in the same family. The financial details for the healthcare services include, without limitation, a service date, a service provider name, a type of visit (e.g., inpatient, outpatient, dental, vision), an insurance company's name, a total bill amount, an estimated reimbursement amount, an insurance payment amount, a patient payment amount, and cumulative totals for each of the above mentioned amounts.

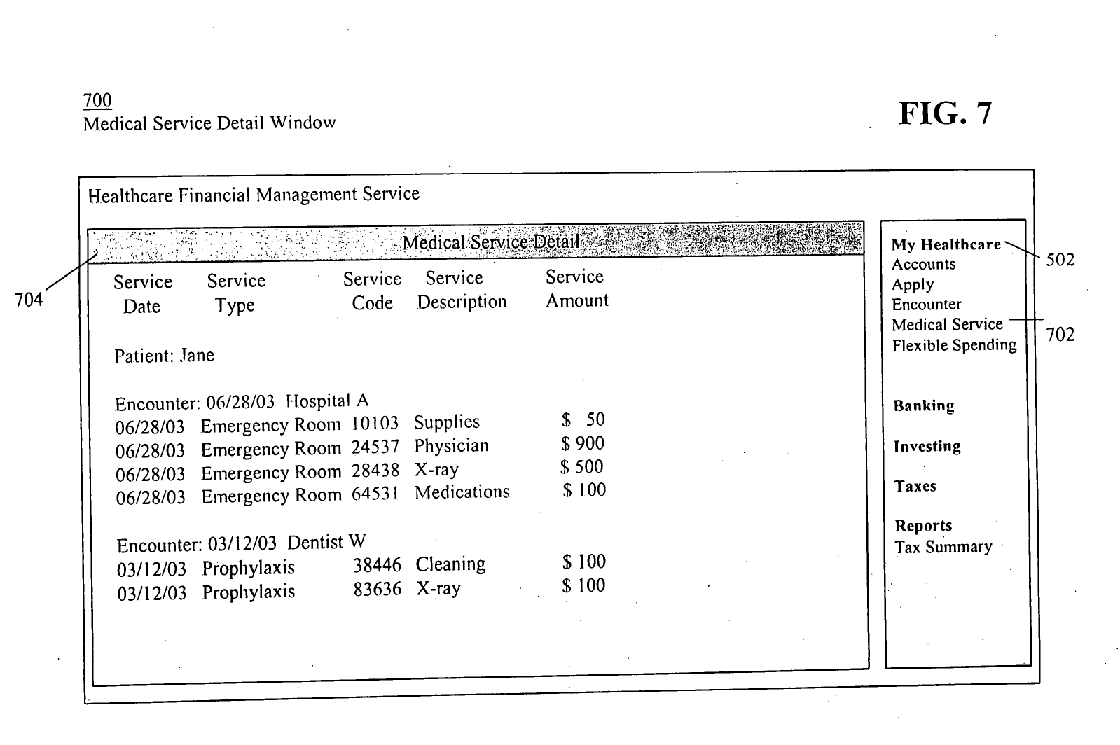

FIG. 7 illustrates a display window 700 on a user interface 212 permitting the subscriber to access medical service details recorded in the system 100, as shown in FIG. 1, in accordance with a preferred embodiment of the present invention. The user (i.e., subscriber) selects the “Medical Service” sub-menu 702 to open a medical service detail section 704. The section 704 permits the user to access financial details of medical services provided by their healthcare providers. The financial details are provided for one or more patients (e.g., Jane), such as patients in the same family. The financial details of medical services include, without limitation, a service date, a service type e.g., emergency room, prophylaxis), a service code, a service description (e.g., supplies, physician, X-ray, medications, cleaning), and a service amount.

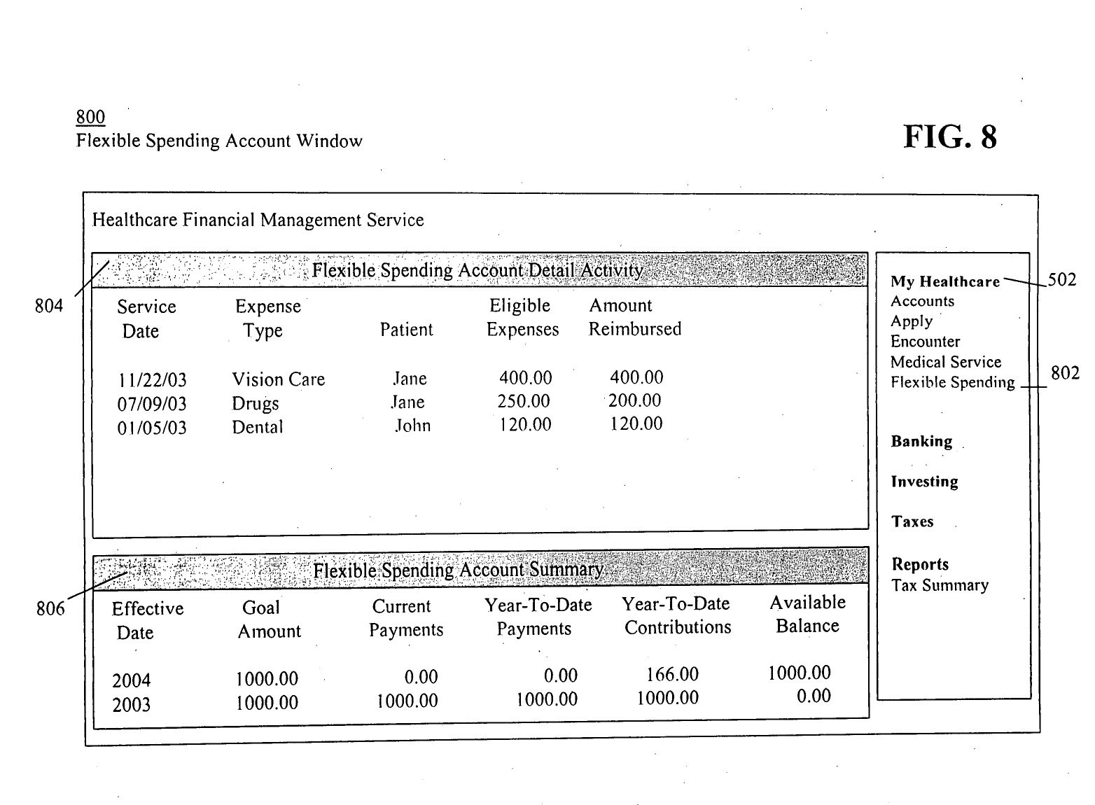

FIG. 8 illustrates a display window 800 on a user interface 212 permitting the subscriber to access flexible spending account activity recorded in the system 100, as shown in FIG. 1, in accordance with a preferred embodiment of the present invention. The user (i.e., subscriber) selects the “Flexible Spending” sub-menu 802 to open flexible spending account activity sections 804 and 806. Section 804 provides the user access to flexible spending account detail activity. Section 806 provides the user access to flexible spending account summary activity. The flexible spending account detail activity section 804 provides details for one or more patients (e.g., Jane, John), such as patients in the same family. The flexible spending account detail activity section 804 includes, without limitation, a service date, an expense type (e.g., vision care, drugs, dental), a patient's name (e.g., Jane, John), eligible. expenses, and an amount reimbursed. The flexible spending account summary activity section 806 includes, without limitation, an effective date, a goal amount, current payments, year-to-date payments, year-to-date contributions, and an available balance.

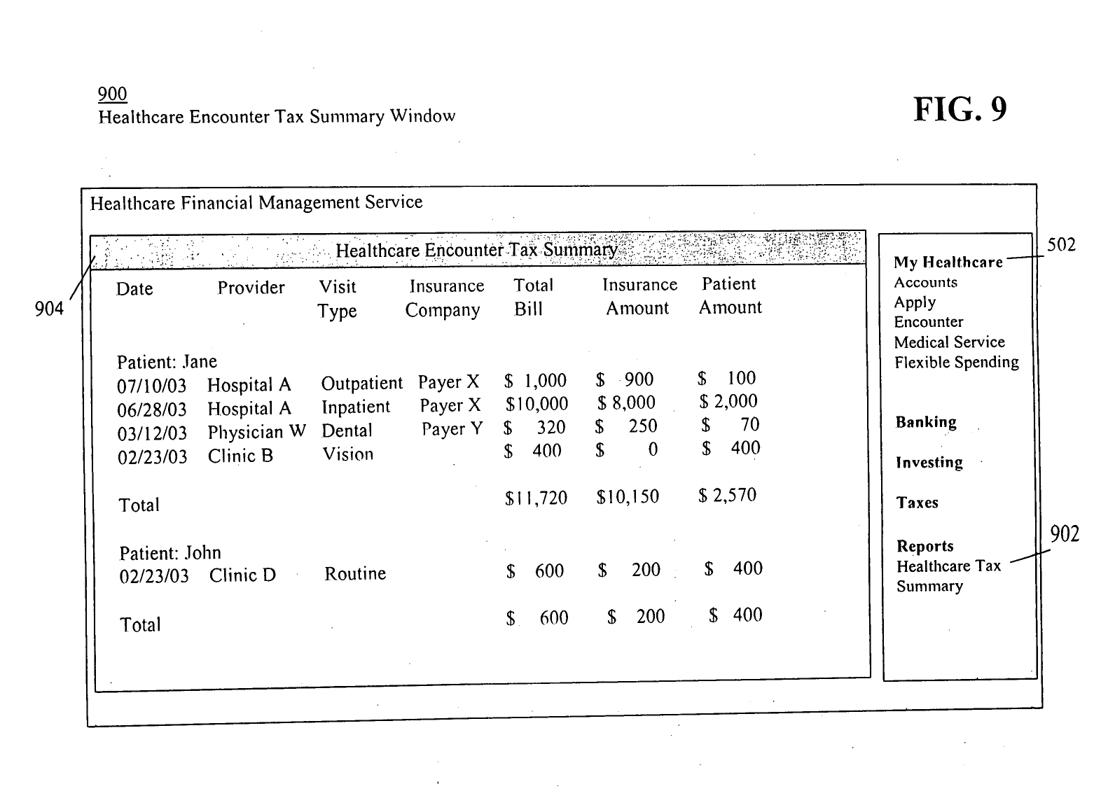

FIG. 9 illustrates a display window 900 on a user interface 212 permitting the subscriber to access tax reports for the healthcare encounters recorded in the system 100, as shown in FIG. 1, in accordance with a preferred embodiment of the present invention. The user (i.e., subscriber) selects the “Healthcare Tax Summary” sub-menu 902 to open the healthcare encounter tax summary section 904. Section 904 provides the user access to a summary of healthcare encounters from a tax reporting perspective to assist the patient in gathering or generating information for filing their personal income taxes. The tax summary section 904 provides details for one or more patients (e.g., Jane, John), such as patients in the same family. The tax summary section 904 includes, without limitation, a service date, a service provider's name, a visit type (e.g., outpatient, inpatient, dental, vision, routine), an insurance company's name, a total bill amount, an insurance amount, a patient amount, and totals for the above mentioned amounts for each patient.

In the preferred embodiment, the tax summary report is for medical and other healthcare expenses. At year-end a user identifies and organizes their healthcare expenses for tax reporting purposes using an electronic, automated process. Instead of a user rummaging through paper bills, the personal system 106 automatically consolidates and categorizes the user's healthcare expenses. Other types of reports are also easily generated including, without limitation, summary of encounters, summary of insurance payments, etc.

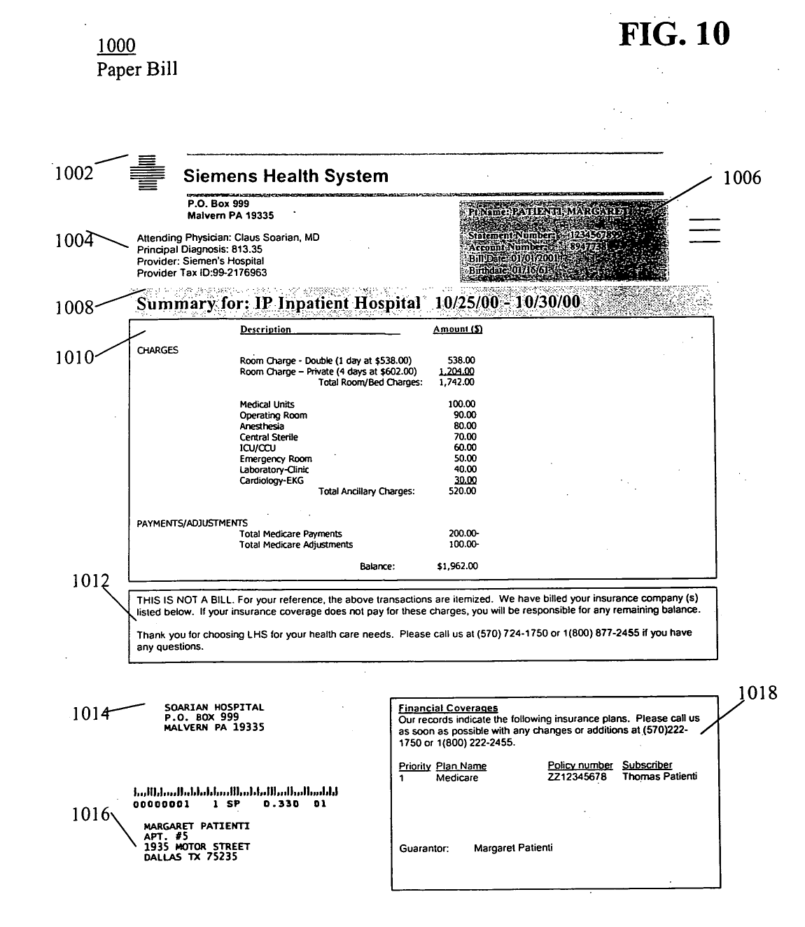

FIG. 10 illustrates a paper bill 1000 for the subscriber, in accordance with a preferred embodiment of the present invention. The paper bill 1000 generally includes a health system name and address 1002, healthcare provider information 1004, patient information 1006, a bill title 1008 (e.g., “Summary for: IP Inpatient Hospital Oct. 25, 2000-Oct. 30, 2000), a detailed description of the services and charges 1010, a special notes section 1012, a return address 1014, a patient address 1016, and insurance information 1018.

The paper bill 1000 provides an example of the kind, amount and level of data generated in the provider system 102 and sent to the personal system 106 via the consumer system 104 in an electronic format. Although paper bill 1000 does not show details related to the services, an electronic version of this billing information would include more details, which are downloaded to the personal system 106. For example, detailed charges for the summary totals of each department identify the specific service provided and the price being charged to the patient for that service.

In summary of a preferred embodiment of the present invention, a system provides a link between personal financial management products 106, such as Quicken or Microsoft Money, and healthcare information systems (HIS) 102 operated by healthcare providers. For patients it provides a convenient way to track, pay, organize, and account for healthcare services received and their associated expense. For providers it provides a service to benefit their customers, and improve receivables, by enabling electronic payment of a patient's bill (e.g. co-payments). The consumer system 104 provides a centralized control module that is used to connect the personal financial management software 106 on patient's personal computer 138 to healthcare provider accounting applications, such as a guarantor statement 103, available in a healthcare information system 102. The consumer system 104 receives detailed billing and payment information 108 from the HIS provider accounting application 102, maintains information on subscribing providers and patients, and provides the detailed billing and payment information 108 to personal financial management software 106 on request. A patient benefits by having a consolidated, electronic record of healthcare services received, and associated costs and payments for tracking insurance coverage and for end of year tax reporting, and a means to electronically pay for outstanding balances. A healthcare provider organization benefits through customer satisfaction and immediate electronic billing of patients, avoided costs for making/printing/sending bills, avoided costs to maintaining accounts receivable work lists, and from receipt of direct deposit payments from patients.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A financial management system enabling an individual user to access and maintain healthcare records concerning encounters of an individual with a healthcare provider organization, said encounters comprising interactions of said individual with said healthcare provider organization having a financial consequence, comprising:
an acquisition processor for receiving, via electronic communication from a healthcare provider organization, information related to at least one healthcare encounter of an individual user;
a storage processor for storing said received healthcare encounter information;
a data processor for retrieving and processing received healthcare encounter information to provide data representing at least one record indicating a history of encounters of said individual user with said healthcare provider organization; and
an output processor for processing said data representing said at least one record for output in response to user command.

2. A system according to claim 1, wherein
said data processor processes said received healthcare encounter information to provide data representing at least one of, (a) a record collating encounter information for encounters subject to similar taxation treatment, (b) a record collating encounter information for encounters subject reimbursement under a particular reimbursement plan, and (c) a record collating encounter information for encounters to be paid for by said individual user.

3. A system according to claim 2, wherein
said record collating encounter information for encounters subject to common taxation treatment collates encounter information by type of service provided to said individual user during an encounter, said type of service comprising at least one of, (a) a medical service, (b) a dental service, (c) an education service and (d) a dependent care related service, and (e) a flexible spending account related service.

4. A system according to claim 1, including
a display generator for initiating generation of data representing a display image presenting said encounter history information, and wherein
said data processor prompts said individual user to initiate payment related to an encounter indicated by said encounter history information.

5. A system according to claim 1, including
a display generator for initiating generation of data representing a display image presenting said encounter history information, and wherein
said data processor at least one of, (a) automatically initiates payment related to an encounter indicated by said encounter history information in response to predetermined payment instruction entered by a user, and (b) terminates an automatically initiated payment related to an encounter in response to user command.

6. A system according to claim 4, including
said data processor prompts said individual user to initiate payment related to an encounter indicated by said encounter history information by at least one of, (a) electronic funds transfer, (b) credit card, and (b) a manual payment method.

7. A system according to claim 1, including
a communication processor for establishing communication with an information system of said healthcare provider organization for acquiring said information related to said at least one healthcare encounter of said individual user.

8. A system according to claim 7, wherein
said communication processor establishes communication with said information system of said healthcare provider organization for acquiring said information related to said at least one healthcare encounter of said individual user in response to at least one of, (a) a command of said individual user, (b) predetermined computerized instruction to establish repetitive intermittent communication, and
said communication processor provides, to said information system, identification information of said individual user together with at least one of, (i) a password and (ii) information identifying said authorization of said individual user to access said information system.

9. A system according to claim 1, including
said data processor processes said received healthcare encounter information by automatically identifying a type of service identified in said received healthcare encounter information by parsing said received healthcare encounter information to identify encounter identification codes.

10. A system according to claim 9, including
said data processor uses said identified encounter identification codes to identify at least one of, (a) a particular service and (b) a particular procedure associated with an encounter, and
said data processor maps said identified identification code to a different code and uses said different code in processing received healthcare encounter information.

11. A system according to claim 1, wherein
said output processor for processing said data representing said at least one record for output in at least one form selected from, (a) electronic form, (b) a printed report form, (c) a file suitable for communication via the Internet, and (d) as data representing a display image for presentation to a user.

12. A system according to claim 1, wherein
said storage processor monitors updates of said stored received healthcare encounter information by maintaining at least one of, (a) a date and (b) a time, of an update to said stored received healthcare encounter information.

13. A system according to claim 1, wherein
said received healthcare encounter information comprises at least one of, (a) an identification of a service provided during an encounter, (b) an identification of a type of patient visit comprising an encounter, (c) a date of an encounter, (d) at least a portion of financial cost of an encounter due to be paid by said individual user, (e) a financial cost of an encounter, (f) an identification of an insurance company responsible for at least a portion of a financial cost of an encounter, (g) identification of a payment made by a user or insurance company towards cost of an encounter, and (h) an estimated reimbursement amount towards cost of an encounter.

14. A system according to claim 1, wherein
said acquisition processor receives family information comprising information concerning at least one healthcare encounter of a person related to said individual user,
said data processor processes said received family information to provide data representing at least one record indicating a history of encounters of said related person.

15. A system according to claim 1, wherein
said acquisition processor receives multi-organization information identifying a plurality of encounters of said individual user with multiple different organizations,
said data processor processes said received multi-organization information to provide data representing at least one record indicating a history of encounters of said individual user with said multiple different organizations.

16. A system according to claim 1, wherein
said acquisition processor receives multi-organization information identifying a plurality of encounters of said individual user with multiple different organizations,
said data processor processes said received multi-organization information to provide data representing at least one of, (a) a record identifying encounters of said individual user with multiple different organizations and said identified encounters subject to common taxation treatment, (b) a record identifying encounters of said individual user with multiple different organizations subject reimbursement under a particular reimbursement plan, and (c) a record identifying encounters of said individual user with multiple different organizations to be paid for by said individual user.

17. A system according to claim 1, wherein
said data processor processes said received healthcare encounter information to initiate generation of a message to said individual user, said message comprising at least one of, (a) an alert concerning healthcare of said individual user, and (b) a reminder concerning a payment to be made concerning an encounter.

18. A system for use by a healthcare provider organization supporting individual user access to healthcare records concerning encounters of an individual with a healthcare provider organization, said encounters comprising interactions of said individual with said healthcare provider organization having a financial consequence, comprising:
an interface processor for receiving user identification and authorization information for identifying authorization of said user to access the healthcare encounter information of said user;
a data processor for,
retrieving said healthcare encounter information of said identified user from storage and
formatting said retrieved healthcare encounter information of said user for communication to a user communication address; and
a communication processor for communicating said formatted healthcare encounter information to said user communication address.

19. A system according to claim 18, wherein
said data processor initiates retrieving said healthcare encounter information in response to at least one of, (a) a received request for download of said healthcare encounter information of said user, and (b) predetermined computerized instruction to establish repetitive intermittent download of said healthcare encounter information to said user destination address.

20. A system according to claim 18, wherein
said system of claim 17 is provided as a service to a subscriber and including
a subscription processor for managing subscription of at least one of, (a) an individual user, and (b) a healthcare organization, to provide said service.

21. A system according to claim 18, wherein
said received healthcare encounter information comprises at least one of, (a) an identification of a service provided during an encounter, (b) an identification of a type of patient visit comprising an encounter, (c) a date of an encounter, (d) at least a portion of financial cost of an encounter due to be paid by said individual user, (e) a financial cost of an encounter, (f) an identification of an insurance company responsible for at least a portion of a financial cost of an encounter, (g) identification of a payment made by a user or insurance company towards cost of an encounter, and (h) an estimated reimbursement amount towards cost of an encounter.

22. A system according to claim 18, wherein
said healthcare provider organization comprises at least one of, (a) one or more hospitals, (b) a grouping of one or more physicians, (c) a clinic, (d) a nursing home, (e) an extended care facility, (f) a home healthcare agency, (g) a pharmacy, (h) a test laboratory, (i) a healthcare enterprise, (j) a fitness center, (k) a rehabilitation center and (l) a diagnostic testing facility.

23. A system according to claim 18, wherein
said interface processor receives notice of a payment related to an encounter performed by at least one of, (a) electronic funds transfer, (b) credit card, (c) a manual payment method and (d) an automatically initiated payment made in response to predetermined payment instruction entered by a user.

24. A system according to claim 18, wherein
said formatted healthcare encounter information includes encounter identification codes for identifying at least one of, (a) a particular service, and (b) a particular procedure associated with an encounter.

25. A system according to claim 18, wherein
said formatted healthcare encounter information includes a map for use in translating an identified identification code to a different code.

26. A method enabling an individual user to access and maintain healthcare records concerning encounters of an individual with a healthcare provider organization, said encounters comprising interactions of said individual with said healthcare provider organization having a financial consequence, comprising the activities of:
receiving, via electronic communication from a healthcare provider organization, information related to at least one healthcare encounter of an individual user;
storing said received healthcare encounter information;
retrieving and processing received healthcare encounter information to provide data representing at least one record indicating a history of encounters of said individual user with said healthcare provider organization; and
processing said data representing said at least one record for output in response to user command.

27. A method for use by a healthcare provider organization supporting individual user access to healthcare records concerning encounters of an individual with a healthcare provider organization, said encounters comprising interactions of said individual with said healthcare provider organization having a financial consequence, comprising the activities of:
receiving user identification and authorization information;
identifying authorization of said user to access the healthcare encounter information of said user;
retrieving said healthcare encounter information of said identified user from storage;
formatting said retrieved healthcare encounter information of said user for communication to a user communication address; and
initiating communication of said formatted healthcare encounter information to said user communication address.
